(19) United States
(12) Patent Application Publication
(10) Pub. No.: US 2025/0068707 A1
(43) Pub. Date: Feb. 27, 2025

(54) COLLABORATIVE CLI SESSIONS

(71) Applicant: INTERNATIONAL BUSINESS MACHINES CORPORATION, Armonk, NY (US)

(72) Inventors: Paritosh RANJAN, Kolkata (IN); Marc P. YVON, Antony (FR); Saurabh YADAV, Bangalore (IN); Prodip ROY, Kolkata (IN); Prosanta SAHA, Kolkata (IN); Bhubaneswar PADHAN, Kolkata (IN)

(73) Assignee: INTERNATIONAL BUSINESS MACHINES CORPORATION, Armonk, NY (US)

(21) Appl. No.: 18/453,202

(22) Filed: Aug. 21, 2023

(51) Int. Cl. G06F 21/31; G06F 21/60

(52) U.S. Cl. CPC G06F 21/31; G06F 21/606

(57) ABSTRACT

Various embodiments are provided herein for collaborating in a shared Command Line Interface (CLI) session in a computing environment having one or more processor devices. A unique CLI session, shared between multiple users and platforms using at least one of a Cloud UI dashboard and CLI tool, is instantiated by a session owner. By virtue of permissions established by the shared, unique CLI session, execution of at least one CLI command is managed in the CLI session by at least one of the session owner and authorized ones of those of the multiple users.

### BACKGROUND

The present invention relates in general to computing systems, and more particularly, to various embodiments for collaboration in a shared Command Line Interface (CLI) session in a computing environment.

### SUMMARY

According to an embodiment of the present invention, a method for collaborating in a shared Command Line Interface (CLI) session in a computing environment having one or more processor devices, is provided. A unique CLI session, shared between multiple users and platforms using at least one of a Cloud UI dashboard and CLI tool, is instantiated by a session owner. By virtue of permissions established by the shared, unique CLI session, execution of at least one CLI command is managed in the CLI session by at least one of the session owner and authorized ones of those of the multiple users.

An embodiment includes a computer usable program product. The computer usable program product includes a computer-readable storage device, and program instructions stored on the storage device. The computer usable program product includes program instructions for implementing the aforementioned collaborative CLI functionality in the computing environment.

An embodiment includes a computer system. The computer system includes a processor, a computer-readable memory, and a computer-readable storage device, and program instructions stored on the storage device for execution by the processor via the memory. In one embodiment, a portion of the computer system is adapted for implementing the aforementioned CLI collaborative functionality, such as a CLI session controller server hosting one or more Application Program Interfaces (APIs).

Thus, in addition to the foregoing exemplary method embodiments, other exemplary system and computer product embodiments are provided.

### BRIEF DESCRIPTION OF THE DRAWINGS

FIG. 1 is a block diagram depicting an exemplary cloud computing node according to an embodiment of the present invention.

FIG. 2 is a block diagram depicting exemplary hardware, firmware, and software for effecting collaborative CLI sessions in a shared CLI environment using websockets, in which at least some of the mechanisms of the present invention are implemented.

FIG. 3 is a flow chart diagram of an exemplary functional flow, effecting collaborative CLI session functionality in shared CLI computing environments, again according to the mechanisms of the present invention.

FIG. 4 is an additional flow chart diagram of an API flow, again effecting collaborative CLI session functionality in shared CLI computing environments, again according to the mechanisms of the present invention.

FIG. 5 is an additional flow chart diagram depicting an exemplary method for effecting collaborative CLI session functionality in shared CLI computing environments, again according to the mechanisms of the present invention.

### DETAILED DESCRIPTION OF THE DRAWINGS

Cloud computing has become the de facto application and infrastructure management platform. Organizations and users create accounts in cloud platforms such as IBM® Cloud, Google Cloud, Amazon® Web Services (AWS), etc. These accounts are then used to provision resources as Software as a Service (SaaS), Platform as a Service (PaaS), Infrastructure as a Service (IaaS), etc. The provisioned cloud resources are then used by the users and the organizations to run and operate their software.

The Cloud Command Line Interface (CLI) is a set of tools that is used to manage resources and applications hosted on Cloud. CLI tooling is used to interact with applications, containers, infrastructure, and other services hosted on the Cloud.

Each Cloud vendor provides as a set, a powerful CLI, and corresponding tools for interacting with the vendor's specific Cloud. In general CLIs enable various application development and management of the Cloud account and resources with relative ease.

At present, the CLIs provided by the various Cloud vendors are not collaborative in nature. Each Cloud user of the Cloud account logs into their CLI in a secluded manner, which obstructs collaboration on the CLI level. Currently, it is not possible for different Cloud users to share and collaborate on a common and shared, CLI.

To address the aforementioned lack of CLI collaboration, the mechanisms of the illustrated embodiments provide solutions for effecting collaborative CLI functionality using shared CLI sessions across vendor specific Cloud platforms as will be further described, following. These mechanisms utilize, in one exemplary embodiment, system components such as a shared CLI session controller server, for implementing collaborative CLI functionality, again as will be described.

In addition, aspects of the illustrated embodiments relate to systems and method for establishing and sharing between various platforms, a Cloud CLI history. In one aspect, the Cloud CLI history is established and/or enabled for providing at least one process using one or more instantiations of the Cloud CLI. One or more commands stored in a shared storage location of the Cloud CLI, and executed using at least another instantiation of the Cloud CLI (such as, for example, by another user on a differing Cloud platform), may be received. This shared command history may be displayed in the Cloud CLI to one user, or all users across platforms. In one example, the shared command history includes one or more of the received CLI commands.

To illustrate further, the mechanisms of the present invention provide, in one exemplary embodiment, users a multi-user, real time participated, CLI interface on the Cloud web dashboard, or the applicable CLI tool (e.g., command prompt, power shell, etc.). The Cloud user may then add the participants of the multi-user shared CLI session either at the time of initiating the session, or add/remove the participants later. The session may, in one exemplary embodiment, be identified by the session owner's username.

To continue the aforementioned exemplary functionality further, in one embodiment, various participants could join the CLI session of the initiator using a command on the aforementioned CLI tool or a click of button on the Web dashboard. The respective participant would then be able to join the shared CLI session only if the session owner would have invited/allowed the participant.

If the shared CLI session commences, in one embodiment, the respective participants would see CLI command and output that would appear on the shared session thereafter. If the session would not have started, then the participant would be notified that the session has not started and asked to wait until the session owner initiates the session.

The session owner may, in an additional embodiment, execute any commands on the shared CLI session, or the command execution control/session control can be handed over to any other user by the current shared CLI session owner. When the command would be executed the CLI session participant, then the command would be executed as per the participant user's access.

In view of the foregoing, in a further embodiment, all authorized users would be provided access to share chat messages, which would appear within the CLI in specific formatting. Once the shared CLI session owner ends the session, then the shared CLI session would end for all the participants.

It should be noted that one or more calculations may be performed using various mathematical operations or functions that may involve one or more mathematical operations (e.g., solving differential equations or partial differential equations analytically or computationally, using addition, subtraction, division, multiplication, standard deviations, means, averages, percentages, statistical modeling using statistical distributions, by finding minimums, maximums or similar thresholds for combined variables, etc.).

In general, as may be used herein, “optimize” may refer to and/or defined as “maximize,” “minimize,” “best,” or attain one or more specific targets, objectives, goals, or intentions. Optimize may also refer to maximizing a benefit to a user (e.g., maximize a trained machine learning scheduling agent benefit). Optimize may also refer to making the most effective or functional use of a situation, opportunity, or resource.

Additionally, optimizing need not refer to a best solution or result but may refer to a solution or result that “is good enough” for a particular application, for example. In some implementations, an objective is to suggest a “best” combination of operations, schedules, PE's, and/or machine learning models/machine learning pipelines, but there may be a variety of factors that may result in alternate suggestion of a combination of operations, schedules, PE's, and/or machine learning models/machine learning pipelines yielding better results. Herein, the term “optimize” may refer to such results based on minima (or maxima, depending on what parameters are considered in the optimization problem). In an additional aspect, the terms “optimize” and/or “optimizing” may refer to an operation performed in order to achieve an improved result such as reduced execution costs or increased resource utilization, whether or not the optimum result is actually achieved. Similarly, the term “optimize” may refer to a component for performing such an improvement operation, and the term “optimized” may be used to describe the result of such an improvement operation.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), static random access memory (SRAM), dynamic random access memory (DRAM), read-only memory (ROM), nonvolatile memory, erasable programmable read-only memory (EPROM or Flash memory), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

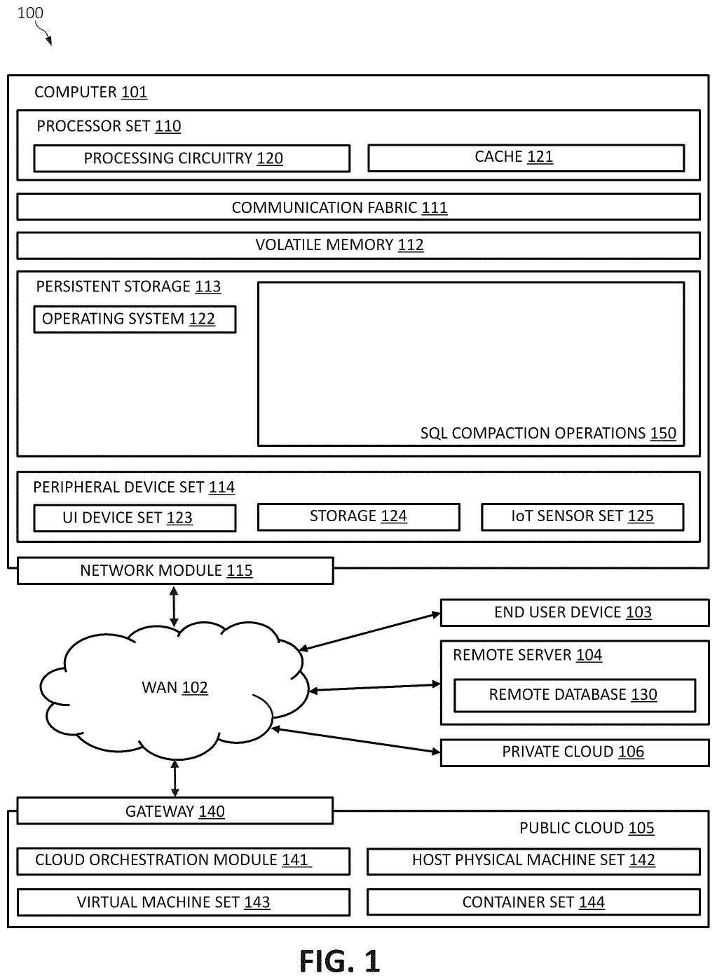

Turning now to FIG. 1, computing environment 100 contains an example of an environment for the execution of at least some of the computer code involved in performing the inventive methods, such as code for acceleration of inflight deployments by inflight deployment module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In one exemplary embodiment, to assist in facilitating collaborative CLI sessions according to the mechanisms of the present invention, various software tools may be leveraged to further some of the ideals of the mechanisms of the present invention, such as tmux, an open-source terminal multiplexer tool. As one of ordinary skill in the art will appreciate, components and aspects of other Cloud-based hardware, software, firmware, or a combination thereof may be leveraged in similar fashion with the injjjkfj.

Consider the following example of facilitating elements of various exemplary embodiments' functionality using the tmux tool. As a first step, a respective host device sends a link of their current CLI session to all of the guest attendees. A tmux session is created for the host: (e.g., ˜tmux new-session-s cloudshell). In the stated example, the central server (i.e., in this case, the Cloudshell) controls the terminal sessions. Commands from all guests would be intercepted by the central server (i.e., again, the Cloudshell). The central server, i.e., Cloudshell would leverage the command ‘˜tmuxsend’ to inject the command into the host's tmux session.

As a follow up step, the Cloudshell updates all instances of the shell with the respective output. The guest attendees may, for example, propose commands to the host attendee for execution. In one example, an important facet of the mechanisms of the illustrated embodiments concerns the ability of the host to retain the authority to approve any guest commands to be executed.

Continuing the stated example further, a number of aspects may be incorporated as follows. The guest attendees may provide requested text input via Cloudshell if prompted/requested. The text input is thereby provided via API calls through the central server (i.e., Cloudshell).

In addition to the host retaining control to approve any guest commands, another potentially important aspect of the illustrated embodiments concerns the ability to protect the control of access to change a particular shared CLI session. To this end, for example, a guest attendee may request access to add and execute a respective commands until the host takes control via API calls through the central server (i.e., Cloudshell).

A session host may wish to protect the ability to lock any session typing to an individual user. When one user is typing, all other users may be blocked from similarly typing. Once the command is injected in the shared CLI session, the block is the removed. In addition, the ability to restrict commands that may proposed may also be incorporate into the functionality underlying the illustrated embodiments. The hosts, for example, may have an “allow” list of commands configured for the session. Accordingly guest attendees would only be able to execute the commands appearing in the allow list. Similarly, a respective host may have a deny list for commands that are not supported by the system (i.e., “rm-rf”).

Finally, a still further technical aspect of the mechanisms of the illustrated embodiments may include the ability to apply artificial intelligence (AI) deep learning functionality to the system to accomplish a wide variety of objectives. For example, the AI may be implemented to assist in proposing allow and deny list candidates. An AI system would learn the type of commands which are not approved and learn to automatically reject commands which are never approved, or the approval percentage is less than a threshold. This threshold may be based on the host's session's historical data or the guest attendee's historical data.

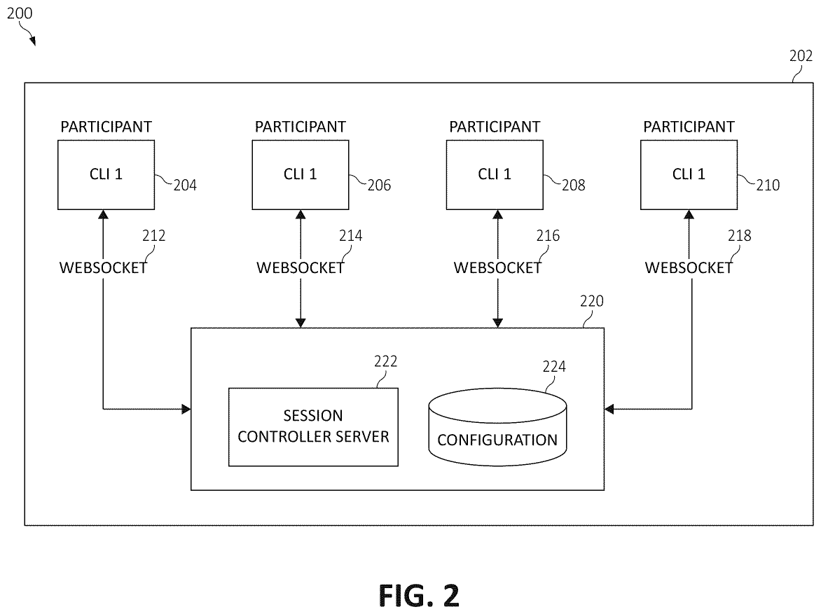

Turning now to FIG. 2, Shared CLI Environment 200 depicts a block diagram 200 of exemplary hardware, firmware, software, and related blocks of functionality for effecting collaborative CLI sessions using WebSockets, according to alternative mechanisms of the present invention. Environment 200 features a number of participants 204, 206, 208, and session host 210 having authorization and related permission(s) to access CLI session control module 220 through WebSockets 212, 214, 216, and 218, which as the skilled artisan will appreciate, enables. As further depicted, CLI session module 220 incorporates hardware, firmware, software, and other functionality associated with the session controller server 222, as well as an affiliated configuration database 224.

Consider the following additional example of using WebSockets 212, 214, 216, and 218 along with affiliated WebSocket protocol(s) to implement some aspects of the mechanisms of the present invention. As one of ordinary skill in the art will appreciate, WebSocket protocol enables ongoing, full-duplex, bi-directional communication between a web client and a web server.

As a preliminary matter considering the example above, and again as previously mentioned, the shared CLI session has a CLI client (i.e., participant 204) and an affiliated session controller server 222. The participant 204 interacts with session controller server 222 with a CLI client tool/utility, e.g., executable, etc. The participants/clients 204,206,208 are connected with the session controller server via full duplex WebSockets 212, 214, and 216. The shared CLI session is, in one embodiment, started by the CLI session host 210 by executing a command.

The CLI command calls an API on the session controller, and registers the session as started. The session-related information may be stored in the configuration/file database 224 on the session module 220. Other participants of the CLI session are added to the session by executing a command with the session ID, for example, with or without credentials, depending on whether the session is an open or protected session. The command may call an API on the session controller 222, which would then connect the respective participant to the now shared CLI session by addition of the participant in the session configuration information 224. The current information about the host 210 and the participants is always present in the session configuration information stored in the session controller server 222. Since the host would be known to the session controller, only the host would be allowed to execute global commands in the session (i.e., commands other than joining and leaving the session executed by the participants). Any other commands executed by non-host participants would be ignored by the session controller 222.

In one embodiment, the host/owner 210 of the shared CLI session can designate another participant/user as a new host 210, by executing commands that call the API in the session controller 222. The session controller 222 then captures information about the new host in the configuration information database 224.

In another embodiment, participants can propose or execute commands as per their specific granted permissions. Placeholders can be placed in proposed commands, which have to be filled in by the executor. Input can be requested from any participant in any step. The input requested can be command or plain text in format. This may be handled, in one embodiment, by sending input request type queries or input/proposal type queries as “COMMAND” OR “TEXT”, etc. Any command executed by the current host would then result in text output locally. The text output may then be captured and pushed to the session controller by the CLI client in regular, configurable intervals (e.g., every 500 ms) by calling an API on the session controller 222. The session controller 222 may then publish the text output received by the other connected clients via the WebSockets 212, 214, 216, and 218. Any changes received by the session controller server 222 may then be propogated to all the connected clients via WebSockets 212, 214, 216, and 218. This enables all of the participants 204, 206, and 208 to view the same command execution and output.

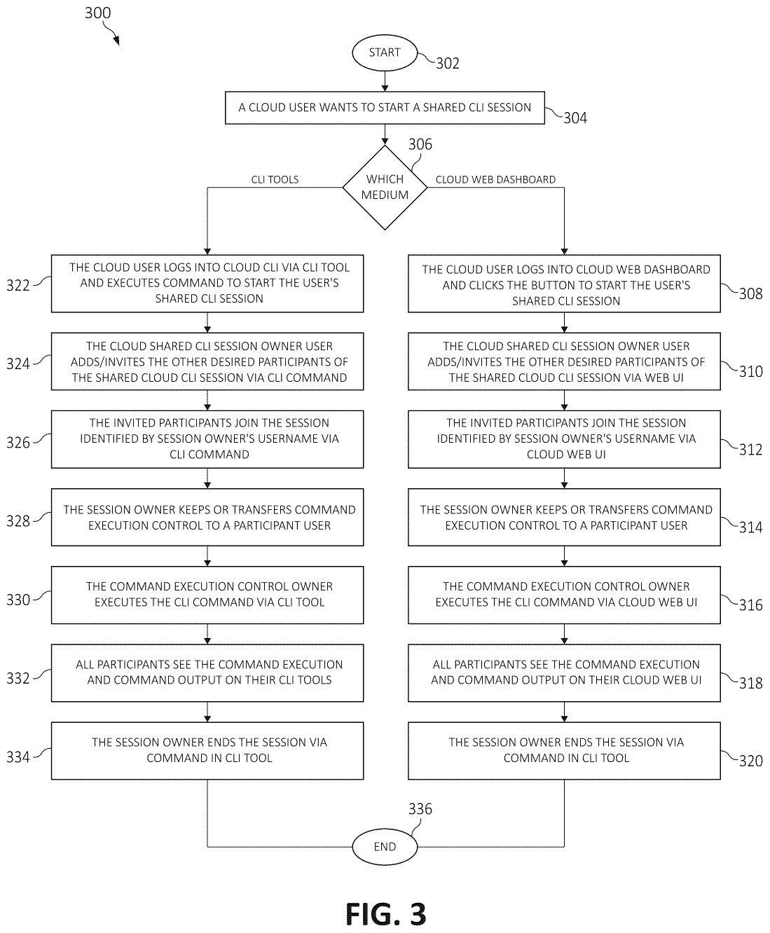

Turning now to FIG. 3, following, an exemplary method 300 for effecting various collaboration functionality through a shared CLI session is depicted, in which various mechanisms of the present invention are realized. Method 300 begins (step 302), with the desire of a Cloud participant within to start a shared CLI session in step 304. Decision step 306, following, queries which medium in which the participant wishes to realize the CLI collaboration. If by use of CLI tools, the method 300 moves to step 322. If by use of a Cloud web dashboard, the method 300 moves to step 308.

Turning now to step 322, the Cloud user logs into the Cloud CLI, via a CLI tool and executes the command to start the user's shared CLI session. In step 324 following, the Cloud shared CLI session owner/user adds/invites the other desired participants of the shared Cloud CLI session via CLI command. The invited participants then join the session identified by the session owner's username via CLI command in step 326. In step 328, following, the session owner keeps or transfers command execution control to an additional participant user. In step 330, the command execution control owner executes the CLI command via the CLI tool. All participants see the command execution and command output on their respective CLI tools in step 332. In step 334, the session owner ends the session via a respective command in the CLI tool. The method 300 then ends in step 336, following.

Returning now to step 306, with the Cloud participant desiring to use a Cloud web dashboard for realization continuing to step 308, the Cloud user logs into the Cloud web dashboard and clicks the button to start the user's shared CLI session. In step 310, the Cloud shared CLI session owner user adds/invites the other desired participants of the shared Cloud CLI session via web UI. In step 312, the invited participants join the session identified by the session owner's username via the Cloud web UI. In step 314, following, the session owner keeps or transfers command execution control to an additional participant user. The command execution control owner then executes the CLI command via the Cloud web UI in step 316. In step 318, all participants see the command execution and output on their respective Cloud web UI. In step 320, the session owner ends the session via a command in the CLI tool, and the method 300 then ends (step 336).

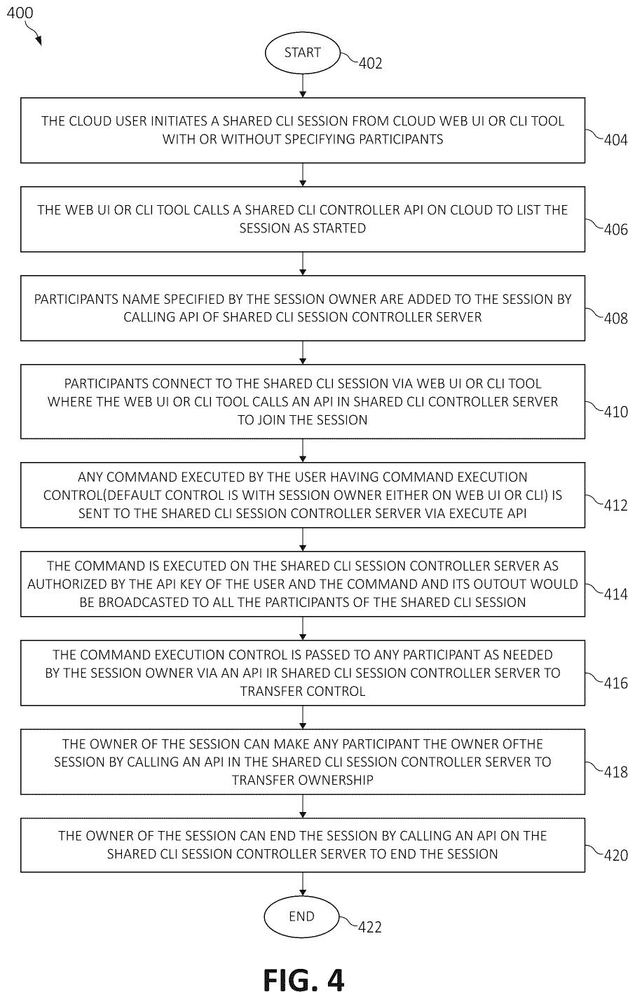

Turning now to FIG. 4, method 400 is depicted by an additional flow chart showing additional collaborative functionality effected by use of the mechanisms of the illustrated embodiments as following. Method 400 begins (step 402) with the initiation of a shared CLI session from the Cloud web UI or CLI tool, with or without specifying participant users (step 404). As a following step, the Web US or CLI tool calls a shared CLI controller API on the Cloud to list the session's status as “started” (step 406). The participants' name specified by the session owner are added to the session by calling the API of the shared CLI session controller server (step 408). Participants connect to the shared CLI session via the Web UI or CLI tool where the Web UI or CLI tool calls an API in the shared CLI controller server to join the session (step 410).

In step 412, following, any command is executed by the user having command execution control. As noted, default control is with the session owner, either on the web UI or CLI is sent to the shared CLI session controller server via execute API. In step 414, following, the command is executed on the shared CLI session controller server as authorized by the API key of the user and the command and its output would be broadcasted to all the participants of the shared CLI session. In step 416, the command execution control is passed to any participant as needed by the session owner via an API in the shared CLI session controller server to transfer control. In step 418, following, the owner of the session can make any participant the owner of the session by calling an API in the shared CLI session controller server to transfer ownership. In step 420, the owner of the session can end the session by calling an API on the shared CLI session controller server to end the session. The method 400 then ends (step 422).

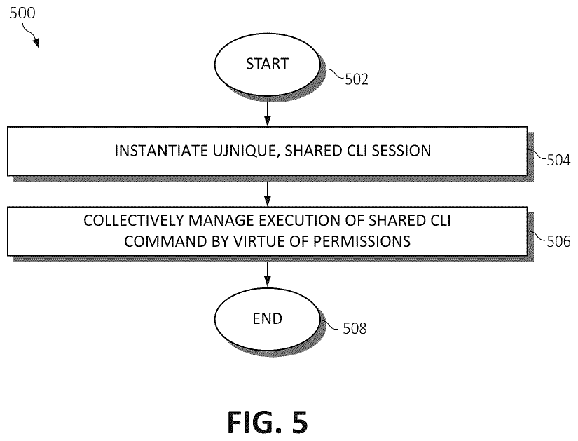

FIG. 5, following, illustrates an additional exemplary method for collaborating in a shared CLI session in a computing environment. Method 500 begins (step 502) by instantiating a unique shared CLI session, shared between multiple users and platforms using at least one of a cloud UI dashboard and CLI tool by a session owner (step 504). In step 506, by virtue of permissions established by the shared, unique CLI session, execution of at least one CLI command is managed in the CLI session by at least one of the session owner and authorized ones of those of the multiple users.

The present invention may be a system, a method, and/or a computer program product. The computer program product may include a computer readable storage medium (or media) having computer readable program instructions thereon for causing a processor to carry out aspects of the present invention. for implementing multiple thread scenes in a computing environment virtualized metaverse, according to an embodiment of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

The descriptions of the embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for collaborating in a shared Command Line Interface (CLI) session in a computing environment having one or more processor devices, comprising:
instantiating a unique CLI session, shared between multiple users and platforms using at least one of a cloud UI dashboard and CLI tool by a session owner; and
by virtue of permissions established by the shared, unique CLI session, managing, by at least one of the session owner and authorized ones of those of the multiple users, execution of at least one CLI command in the CLI session.

2. The method of claim 1, further including performing at least one of receiving from, and executing those of the at least one CLI command from, an additional CLI shared within the CLI session in the computing environment by one of the authorized ones of those of the multiple users.

3. The method of claim 2, further including displaying a CLI history within the CLI session on either of the CLI, the additional CLI, or a further additional CLI.

4. The method of claim 3, further including displaying those of the at least one CLI command being executed within the CLI session.

5. The method of claim 1, further including applying an Artificial Intelligence (AI) deep learning process within the CLI session to at least one of propose, allow, and deny list candidates for the at least one command.

6. The method of claim 1, further including performing at least one of proposing and executing one of direct and approved ones of the at least one command to a host attendee for execution.

7. The method of claim 1, further including performing at least one of:
accepting a requested text input via a Cloud shell for at least one of a CLI command construction and a mid-step question of an execution of the at least one command,
locking an input in the CLI session to an individual user, blocking other users from providing additional input during the input of the CLI session,
granting control of access to any specific user at a time to make changes and execute the at least one command to the CLI session,
transferring control of the execution of the at least one command to other participants of the CLI session,
restricting the at least one command,
inviting other Cloud users to participate in the CLI session,
removing the other Cloud users from the CLI session,
establishing a chat between the other cloud users of the CLI session, wherein messages from the chat are displayed in one of a differing format and section on one of a web user interface and the CLI, and
ending the CLI session.

8. A system for collaborating in a shared Command Line Interface (CLI) session in a computing environment having one or more processor devices, comprising:
a CLI session controller server hosting one or more Application Program Interfaces (APIs), incorporating the one or more processor devices, further having executable instructions that when executed cause the system to:
instantiate a unique CLI session, shared between multiple users and platforms using at least one of a cloud UI dashboard and CLI tool by a session owner, and
by virtue of permissions established by the shared, unique CLI session, manage, by at least one of the session owner and authorized ones of those of the multiple users, execution of at least one CLI command in the CLI session.

9. The system of claim 8, wherein the executable instructions when executed cause the system to perform at least one of receiving from, and executing those of the at least one command from, an additional CLI shared within the CLI session in the computing environment by one of the authorized ones of those of the multiple users.

10. The system of claim 9, wherein the executable instructions when executed cause the system to display a CLI history within the CLI session on either of the CLI, the additional CLI, or a further additional CLI.

11. The system of claim 10, wherein the executable instructions when executed cause the system to display those of the at least one command being executed within the CLI session.

12. The system of claim 8, wherein the executable instructions when executed cause the system to apply an Artificial Intelligence (AI) deep learning process within the CLI session to at least one of propose, allow, and deny list candidates for the at least one command.

13. The system of claim 8, wherein the executable instructions when executed cause the system to perform at least one of proposing and executing one of direct and approved ones of the at least one command to a host attendee for execution.

14. The system of claim 8, wherein the executable instructions when executed cause the system to perform at least one of:
accept a requested text input via a Cloud shell for at least one of a CLI command construction and a mid-step question of an execution of the at least one command,
lock an input in the CLI session to an individual user, blocking other users from providing additional input during the input,
grant control of access to any specific user at a time to make changes and execute the one or more commands to the CLI session,
transfer control of the execution of the at least one command to other participants of the CLI session,
restrict the at least one command,
invite other cloud users to participate in the CLI session,
remove the other cloud users from the CLI session,
establish a chat between the other cloud users of the CLI session, wherein messages from the chat are displayed in one of a differing format and section on one of a web user interface and the CLI, and
end the CLI session.

15. A computer program product for collaborating in a shared Command Line Interface (CLI) session in a computing environment having one or more processor devices, the computer program product comprising:
one or more computer readable storage media, and program instructions collectively stored on the one or more computer readable storage media, the program instructions comprising:
program instructions to instantiate a unique CLI session, shared between multiple users and platforms using at least one of a cloud UI dashboard and CLI tool by a session owner, and
program instructions to, by virtue of permissions established by the shared, unique CLI session, manage, by at least one of the session owner and authorized ones of those of the multiple users, execution of at least one CLI command in the CLI session.

16. The computer program product of claim 15, further including program instructions to perform at least one of receiving from, and executing those of the at least one CLI command from, an additional CLI shared within the CLI session in the computing environment by one of the authorized ones of those of the multiple users.

17. The computer program product of claim 16, further including program instructions to display a CLI history within the CLI session on either of the CLI, the additional CLI, or a further additional CLI.

18. The computer program product of claim 17, further including program instructions to apply an Artificial Intelligence (AI) deep learning process within the CLI session to at least one of propose, allow, and deny list candidates for the at least one CLI command.

19. The computer program product of claim 15, further including program instructions to apply an Artificial Intelligence (AI) deep learning process to at least one of the shared CLI history, the at least one process, the sending, and the storing of the at least one CLI command to at least one of propose, allow, and deny list candidates for the at least one CLI command.

20. The computer program product of claim 15, further including program instructions to perform at least one of proposing and executing one of direct and approved ones of the at least one CLI command to a host attendee for execution.

21. The computer program product of claim 15, further including program instructions to perform one or more of:
accepting a requested text input via a Cloud shell for at least one of a CLI command construction and a mid-step question of an execution of the at least one CLI command,
locking an input in the CLI session to an individual user, blocking other users from providing additional input during the input,
granting control of access to any specific user at a time to make changes and execute the at least one CLI command to the CLI session,
transfer control of the execution of the at least one CLI command to other participants of the CLI session,
restricting the at least one CLI command,
inviting other cloud users to participate in the CLI session,
removing the other cloud users from the CLI session,
establishing a chat between the other cloud users of the CLI session, wherein messages from the chat are displayed in one of a differing format and section on one of a web user interface and CLI, and
ending the CLI session.
